(19) United States
(12) Patent Application Publication
(10) Pub. No.: US 2008/0228584 A1
(43) Pub. Date: Sep. 18, 2008

(54) Method of doing business associated with synthetic turf fields in exchange for rights to media/advertising permits and/or sites

(76) Inventor: John Huard, South Portland, ME (US)

Correspondence Address: FACTOR & LAKE, LTD, 1327 W. WASHINGTON BLVD., SUITE 5G/H, CHICAGO, IL, 60607, US

(21) Appl. No.: 12/075,616

(22) Filed: Mar. 12, 2008

Related U.S. Application Data
(60) Provisional application No. 60/894,955, filed on Mar. 15, 2007.

(51) Int. Cl. G06Q 30/00

(52) U.S. Cl. 705/14; 705/1

(57) ABSTRACT

The present invention comprises a method by which synthetic turf fields are sold to entities capable of granting permits for advertising billboards. The method generally comprises the steps of offering a synthetic turf field to an entity in at least partial exchange for an expedited granting of a billboard permit from the entity. After an agreement on the permit is reached, the turf will be installed. The seller and/or installer of the turf will then sell and/or lease rights under the permit to a third party in exchange for a monetary amount which at least partially covers the cost of the turf.

### RELATED APPLICATION

The present invention claims the benefit of the priority date of U.S. Provisional Patent Application Ser. No. 60/894,955, filed Mar. 15, 2007, and is incorporated by reference herein.

### FIELD OF THE INVENTION

The present invention relates to a method for the sale and installation of synthetic turf fields to government entities for a minimal cost, and in particular for the sale of synthetic turf fields to government entities in exchange for an approved permit and location to construct an advertising billboard, enabling the seller of the synthetic turf field to recoup the cost of creating and installing the synthetic turf field by selling the approved permit and location for the billboard to a third party.

### BACKGROUND ART

Advances in the methods of creation and installation of synthetic turf fields have made such fields relatively safe and consistent, much like natural grass fields, while keeping the cost and time required to maintain such fields at a minimum. Such fields with synthetic surfaces are not susceptible to overuse like fields with a natural grass surface and as a result can be used for numerous events on the same day or on consecutive days without damaging the field. For example, a stadium or field with a synthetic surface could host a concert on a Friday night, multiple soccer games all day the following Saturday, and multiple football games all day the following Sunday without requiring much, if any, maintenance. Hosting a series of events like the aforementioned on a natural grass surface would typically cause great damage to the surface and require large amounts of time and money to be spent repairing, replacing or re-growing the field. The effects of natural wear require that a natural grass field be constantly maintained, making the cost to the owner of the field very large over the field's lifetime. Additionally, being able to have artificial turf fields instead of natural grass fields means a government entity will require less fields and staff to maintain the fields to support community functions, while increasing the revenue each individual field can generate. Further, in areas where water conservation is a concern, synthetic turf surfaces allow for a government entity to conserve an important resource that natural grass surfaces require for standard maintenance.

While many government entities recognize the benefits of synthetic turf fields, the initial cost of installation, generally in the range of several hundred thousand dollars, prevents many government entities from purchasing and installing such a field because of budgetary constraints. Therefore, despite the aforementioned long term savings that will be recognized from a synthetic turf field, many government entities forego installing such a field because the initial amount of money required to install the field would overextend the entities' budget. The present invention seeks to provide government entities seeking the benefits of a synthetic turf field with a method for purchasing such a field for substantially less cost, or no cost at all, while, at the same time, ultimately ensuring the sellers and/or installers of synthetic turf fields receive the proper proceeds for installing such fields.

Billboards are a well known method for advertising that, when strategically placed, reach a large number of consumers for a minimal cost. Generally, a location for a billboard is granted by a government entity after an advertiser applies for a permit to construct a billboard. In order to receive a permit and location for a billboard, a party must apply to the government entity controlling the land on which it wishes to advertise, for example the city in which it wishes to advertise, and pay a fee, typically in the range of a few thousand dollars. However, once an application for a permit and location is submitted to a government entity, a delay of 2-3, and sometimes as many as 5-7 years is common before a permit and location is granted by the government entity entitling the advertiser to create the billboard. This delay, however, can be waived by the government entity at anytime. Once granted, the rights to a permit and location for a billboard can be sold for several hundred thousand dollars to parties seeking an immediate billboard location. Billboard locations may also be rented for a periodic fee in lieu of selling the permit and location. If a government entity immediately grants a billboard permit and location to a synthetic turf field seller/installer, the revenue the seller of the synthetic turf field derives from the sale or rental of the approved permit and location for the billboard should at least substantially recoup the costs and profits of otherwise associated with the installation and selling of the synthetic turf field.

### SUMMARY OF THE PRESENT INVENTION

In view of the above, it is an object of the present invention to provide a method whereby government entities seeking the benefits a synthetic turf field can have such a field installed for minimal or no costs.

It is a further object of the present invention to provide a method whereby government entities can immediately or expeditiously grant billboard permits and locations, in lieu of money, in exchange for a synthetic turf field.

It is a further object of the present invention to provide a method through which parties can purchase an approved permit and location for a billboard and not have to suffer the delays associated with review and approval from a government entity.

It is a further object of the present invention to provide a method whereby synthetic turf field sellers and/or installers can recoup at least substantially all of the costs resulting from creating and installing a synthetic turf field by selling billboard permits and locations, granted by a government entity in exchange for an synthetic turf field, to a third party seeking an immediate media structure location.

These and other objects will become apparent to those having ordinary skill in the art having the present specification and claims before them.

### DETAILED DESCRIPTION OF THE PREFERRED EMBODIMENT

In a preferred embodiment of the present invention, a government entity wishing to purchase a synthetic turf field at minimal or no cost expeditiously grants a permit and location for a billboard to a seller of synthetic turf fields. The seller then installs a synthetic turf field at a location designated by the government entity. The synthetic turf field seller and/or installer then sells the approved permit and location for constructing a billboard to any interested third party, recovering at least a substantial portion of the cost of creating and installing the new synthetic turf field. In another preferred embodiment of the present invention, the synthetic turf field seller retains the permit and location for constructing a billboard granted by the government entity, and rents media structure space to third parties to recover the costs of installing the synthetic turf field over a period of time.

While the preferred embodiment describes a media structure as a billboard, it will be understood for the purposes of this invention that media structure also includes cellular phone towers, telecommunication towers and other publicly available media platforms. Although the above contemplates and describes specific preferred methods, it will be understood that the invention in its broad aspects includes equivalent methods to those described herein.

What is claimed is:

1. A method by which synthetic turf fields are sold to entities capable of granting permits for a media structure comprising the steps of:
offering a synthetic turf field to an entity in at least partial exchange for an expedited granting of a media structure permit from the entity;
installing a synthetic turf field in exchange for at least an agreement by the entity to provide an expedited granting of the media structure permit; and
obtaining a permit to construct a media structure from the entity.

2. The method according to claim 1 further comprising the step of selling the rights to the permit to a third party.

3. The method according to claim 2 wherein the step of selling the rights to the permit comprises selling the rights for a price which at least covers the cost of the synthetic turf field.

4. The method according to claim 1 further comprising the step of licensing rights to the media structure to a third party.

5. The method according to claim 1 further comprising the step of renting or leasing rights under the permit to a third party.

6. The method according to claim 1 wherein the step of offering a synthetic turf field to an entity in at least partial exchange for an expedited granting of a media structure permit from the entity further includes the step of offering the synthetic turf field to the entity at a discounted rate.

7. The method of claim 1 where the entity includes one of countries, states, commonwealths, counties, cities, townships, municipalities, villages, park districts and the like.

8. The method of claim 1 where the permit for a media structure is granted by the entity without normal delays associated therewith.

9. The method according to claim 1 wherein the step of granting the permit includes the step of granting the permit so that it is transferable to a third party.
